(19) United States
(12) Patent Application Publication
(10) Pub. No.: US 2024/0310053 A1
(43) Pub. Date: Sep. 19, 2024

(54) HEATING COOKER

(71) Applicant: SAMSUNG ELECTRONICS CO., LTD., Suwon-si (KR)

(72) Inventors: Takaaki KATSUURA, Kanagawa (JP); Yuki TOKURA, Kanagawa (JP)

(21) Appl. No.: 18/672,015

(22) Filed: May 23, 2024

Related U.S. Application Data
(63) Continuation of application No. PCT/KR2022/016679, filed on Oct. 28, 2022.

(30) Foreign Application Priority Data
Dec. 24, 2021 (JP) 2021-210916

(51) Int. Cl. F24C 15/00

(52) U.S. Cl. CPC F24C 15/004

(57) ABSTRACT

A heating cooker for cooking a food ingredient includes a case in which a heating chamber configured to accommodate the food ingredient is defined, a heating unit configured to heat an inside of the heating chamber, a control unit configured to control the heating unit, and a food ingredient temperature detection unit configured to detect, in a contactless manner, a surface temperature of the food ingredient being cooked in the heating chamber. A window member is disposed between the food ingredient temperature detection unit and the heating chamber. The control unit corrects the surface temperature of the food ingredient detected by the food ingredient temperature detection unit, based on at least the temperature of the window member.

### CROSS-REFERENCE TO RELATED APPLICATIONS

This application is a continuation application, under 35 U.S.C. §111(a), of International Patent Application No. PCT/KR2022/016679, filed on Oct. 28, 2022, which claims priority to Japanese Patent Application No. 2021-210916, filed on Dec. 24, 2021, the content of which in its entirety is herein incorporated by reference.

### FIELD

The disclosure relates to a heating cooker for cooking food ingredients by applying heat.

### BACKGROUND ART

Heating cookers use a technique for detecting the temperature of food ingredients in a contactless manner. Japanese Patent No. 3395613 discloses a heating cooker having a detection hole in a heating chamber thereof and being capable of detecting the temperature of food ingredients in a contactless manner by detecting infrared rays inside the heating chamber through the detection hole. In order to prevent an infrared sensor from being contaminated by products from food ingredients, a shutter disk with an infrared-transmitting part is installed between food ingredients and the infrared sensor.

### SUMMARY

A heating cooker for cooking food ingredient according to a feature of the disclosure includes a case in which a heating chamber which is configured to accommodate the food ingredient is defined. A heating unit heats the inside of the heating chamber. A control processor controls the heating unit. A food ingredient temperature detection unit detects in a contactless manner the surface temperature of the food ingredients being cooked in the heating chamber. A window member is disposed between the food ingredient temperature detection unit and the heating chamber. The control processor corrects the surface temperature of the food ingredients detected by the food ingredient temperature detection unit, based on at least the temperature of the window member.

### DESCRIPTION OF DRAWINGS

The above and other exemplary embodiments, advantages and features of this disclosure will become more apparent by describing in further detail exemplary embodiments thereof with reference to the accompanying drawings, in which:

FIG. 1 is a schematic overall configuration diagram of an embodiment of a heating cooking system including a heating cooker, according to the disclosure.

FIG. 2 is a perspective view of an embodiment of a heating cooker according to the disclosure, as seen from an upper right side.

FIG. 3 is a perspective view of an embodiment of a heating cooker according to the disclosure, as seen from a lower right side.

FIG. 4 is a front view of an embodiment of the inside of a heating chamber of a heating cooker, according to the disclosure.

FIG. 5 is a cross-sectional view taken along line V-V of FIG. 4.

FIG. 6 is a schematic diagram of an embodiment of a food ingredient temperature detection unit according to the disclosure.

FIG. 7 is a schematic diagram of an embodiment of a food ingredient temperature detection unit according to the disclosure.

FIG. 8 is a block diagram illustrating a control unit and related components thereof, according to the disclosure.

FIG. 9 is a flowchart of an embodiment of heating control according to the disclosure.

FIG. 10 is a schematic diagram of an embodiment of a food ingredient temperature detection unit according to the disclosure.

FIG. 11 is a schematic diagram of an embodiment of a food ingredient temperature detection unit according to the disclosure.

FIG. 12 is a schematic diagram of an embodiment of a food ingredient temperature detection unit according to the disclosure.

FIG. 13 is a schematic diagram of an embodiment of a window member temperature detection unit according to the disclosure.

FIG. 14 is a flowchart of an embodiment of heating control according to the disclosure.

FIG. 15 is a schematic diagram of an embodiment of an in-sensor temperature detection unit according to the disclosure.

### DETAILED DESCRIPTION

Although the terms used herein are selected from among common terms that are currently widely used in consideration of their functions in the disclosure, the terms may be different according to an intention of one of ordinary skill in the art, a precedent, or the advent of new technology. Also, in particular cases, the terms are discretionally selected by the applicant of the disclosure, in which case, the meaning of those terms will be described in detail in the corresponding part of the detailed description. Therefore, the terms used herein are not merely designations of the terms, but the terms are defined based on the meaning of the terms and content throughout the disclosure. Throughout the specification, when a part “includes” a component, it means that the part may additionally include other components rather than excluding other components as long as there is no particular opposing recitation.

Hereinafter, embodiments of a heating cooker according to the disclosure will be described in detail with reference to the accompanying drawings such that those of skill in the art may easily implement the disclosure. The disclosure may be embodied in many different forms and should not be construed as being limited to an embodiment set forth herein. In order to clearly describe the disclosure, portions that are not relevant to the description of the disclosure are omitted, and similar reference numerals are assigned to similar elements throughout the specification.

In the following description, the upper side of a heating cooker in the vertical direction is referred to as “top” and the lower side is referred to as “bottom”, a door side of a heating chamber is referred to as “front”, the side opposite to the door side is referred to as “rear”, and the left side when viewed from the front where the door is installed is referred to as “left”, and the right side is referred to as “right”. In addition, the drawings are for conceptually describing the disclosure. Thus, in the drawings, dimensions, ratios, or numbers may be exaggerated or simplified to facilitate understanding of the disclosure.

The term “unit” as used herein may be intended to mean a hardware component including a circuitry such as a field-programmable gate array (“FPGA”) or an application-specific integrated circuit (“ASIC”), for example, unless particularly defined.

The temperature of food ingredients being cooked may be detected in a contactless manner by an infrared sensor. However, when the internal temperature of a heating chamber is greater than 100 degrees Celsius (C) during heating with a heater such as an oven or a grill, it is desired to protect the infrared sensor from being exposed to relatively high heat. Thus, it may be difficult to accurately detect the surface temperature of food ingredients being cooked, by a non-contact sensor such as an infrared sensor. The disclosure provides a structure capable of accurately detecting the surface temperature of food ingredients in a contactless manner even when the internal temperature of a heating chamber in a heating cooker rises to a relatively high temperature.

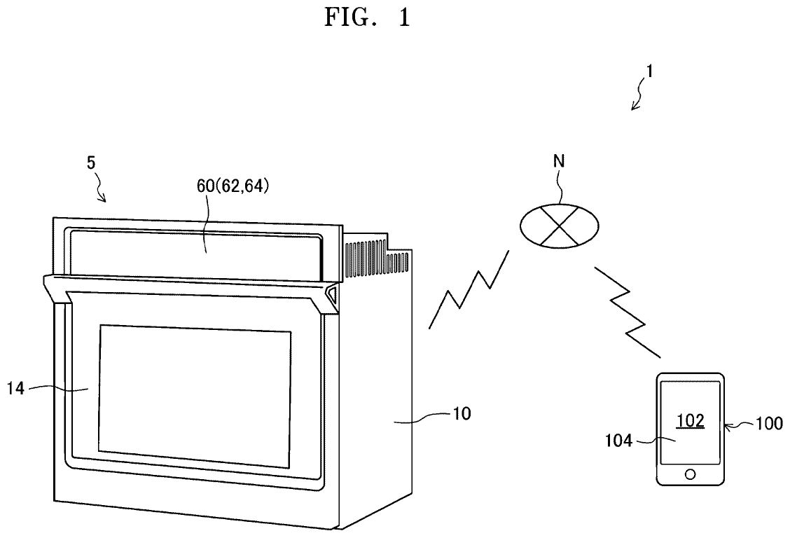

FIG. 1 is a schematic overall configuration diagram of an embodiment of a heating cooking system including a heating cooker, according to the disclosure. Referring to FIG. 1, a heating cooking system 1 may include a heating cooker 5 and an information terminal 100. The heating cooking system 1 may be a system for providing a user using the heating cooker 5 with information about food ingredients F being cooked (e.g., the surface temperature of the food ingredients F). The providing of the information by the heating cooking system 1 helps the user using the heating cooker 5 to check the cooking state of the food ingredients F being heated and cooked.

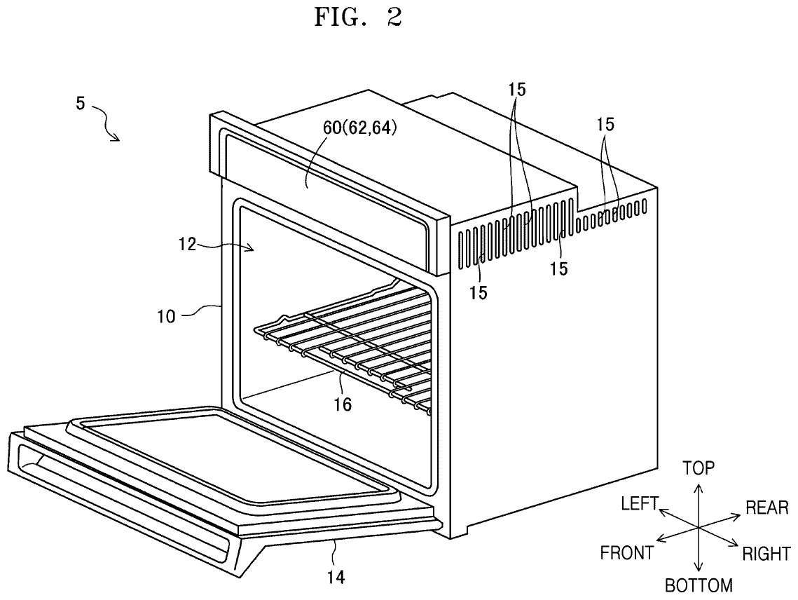

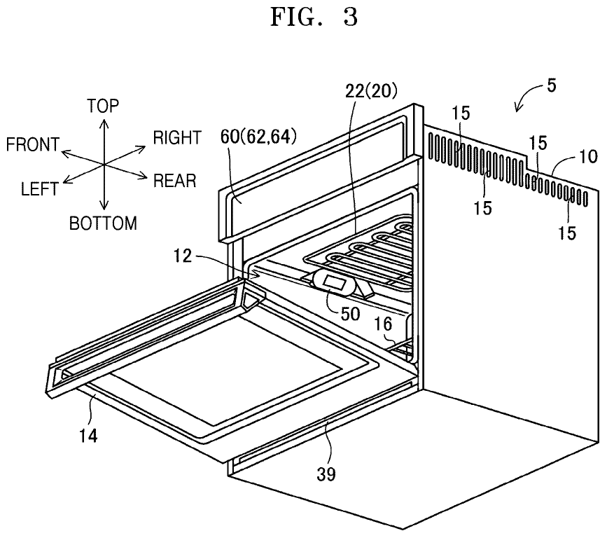

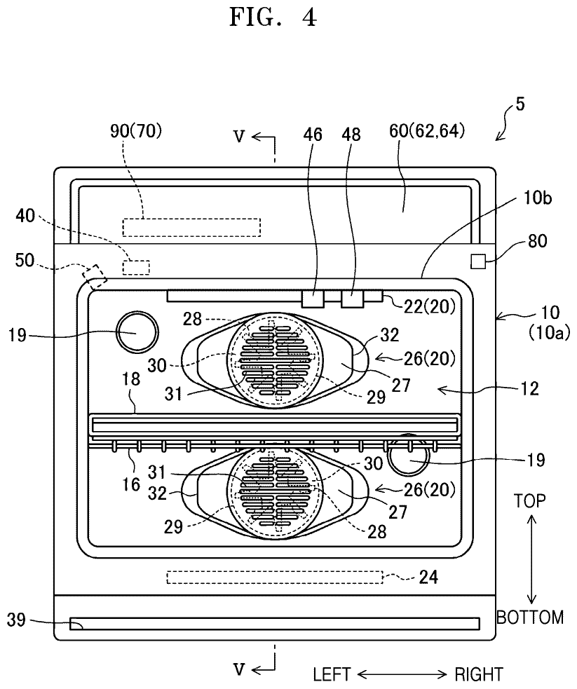

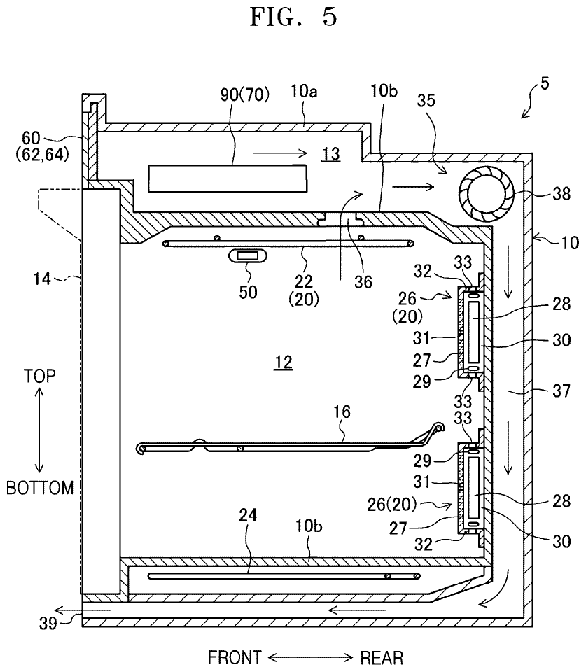

The heating cooker 5 may be also referred to as a convection oven. The heating cooker 5 may have a function of automatically heat-cooking the food ingredients F. FIG. 2 is a perspective view of an embodiment of the heating cooker 5 according to the disclosure, as seen from an upper right side. FIG. 3 is a perspective view of an embodiment of the heating cooker 5 according to the disclosure, as seen from a lower right side. FIG. 4 is a front view of an embodiment of the inside of a heating chamber 12 of the heating cooker 5, according to the disclosure. FIG. 5 is a cross-sectional view taken along line V-V of FIG. 4. Referring to FIGS. 2 to 5, the heating cooker 5 may include the heating chamber 12, a heating unit 20, a food ingredient temperature detection unit 40, and a control unit(control processor) 90. The heating cooker 5 may further include a three-dimensional measurement unit 46, an in-chamber temperature detection unit 48, a photographing unit 50, a display unit 62, a manipulation unit 64, a memory unit 70, and a locking mechanism 80.

The heating chamber 12 is defined in a case 10. The food ingredients F are placed in the heating chamber 12. In embodiments, the food ingredients F may include meat, fish, shellfish, vegetables, and those being cooked. The case 10 may be a quadrangular box, e.g., rectangular parallelepiped box, with an open front side. The heating chamber 12 may be formed by an internal space of the case 10. The case 10 may include an outer housing 10a and an inner housing 10b. The outer housing 10a forms an exterior portion of the case 10. The inner housing 10b forms an inner wall of the heating chamber 12. A ventilation flow path 13 is formed between the outer housing 10a and the inner housing 10b. The ventilation flow path 13 is a flow path for flowing air introduced from the outside, and air introduced from the inside of the heating chamber 12.

A door 14 is installed on a front surface (opening surface) of the case 10. The door 14 is connected to the case 10 to be rotatable in the vertical direction by a hinge (not shown) provided below the opening of the case 10. The door 14 opens and closes the heating chamber 12 by rotating in the vertical direction. The locking mechanism 80 is installed around the opening of the case 10 and on the opposite side of the door 14 (the upper right side in the example illustrated in FIG. 4). The locking mechanism 80 is a mechanism that locks the door 14 closed.

A shelf 16 is installed in the heating chamber 12. In an embodiment, the shelf 16 may include a quadrangular frame member, e.g., rectangular frame member, including or consisting of wire, and a plurality of rod-shaped members disposed in the left-right direction while crossing the inside of the frame member in the front-rear direction, for example. Opposite ends of the shelf 16 in the left-right direction are supported by a sidewall of the case 10, that is, a side surface that partitions the heating chamber 12. A tray 18 is placed on the shelf 16. The tray 18 may include or consist of a metal plate. The food ingredients F are placed on the tray 18.

An in-chamber lamp 19 may be installed on a rear wall of the case 10, that is, a rear surface that partitions the heating chamber 12. In an embodiment, two in-chamber lamps 19 may be installed in two upper and lower areas into which the heating chamber 12 is partitioned, respectively, for example. One in-chamber lamp 19 may be disposed on an upper left side of the heating chamber 12, and the other in-chamber lamp 19 may be disposed on the lower right side of the heating chamber 12. The in-chamber lamp 19 illuminates the inside of the heating chamber 12 such that the state or the like of the food ingredients F being heated and cooked may be easily checked. The in-chamber lamp 19 may include an incandescent bulb, a fluorescent bulb, or a light-emitting diode (LED) bulb, for example.

The heating unit 20 heats the inside of the heating chamber 12. The heating unit 20 may include a plurality of heaters. In an embodiment, as illustrated in FIGS. 2 to 5, the plurality of heaters may include an upper heater 22, a lower heater 24, and a convection heater 26, for example. The outputs of the upper heater 22, the lower heater 24, and the convection heater 26 may be individually and independently adjusted by the control unit 90, which will be described below.

The upper heater 22 may be installed on an upper wall of the case 10. In an embodiment, the upper heater 22 may be disposed along the upper surface of the inner housing 10b, for example. The lower heater 24 may be installed on a lower wall of the case 10. In an embodiment, the lower heater 24 may be buried below the lower surface of the inner housing 10b, for example. The upper heater 22 and the lower heater 24 may each include a heating wire that generates heat by supplying of an electric current, for example. The upper heater 22 and the lower heater 24 may be infrared heaters that emit infrared rays, or may be a combination of a heating wire and an infrared heater.

The convection heater 26 may be installed on the rear wall of the case 10, that is, on the rear surface that partitions the heating chamber 12, in a central portion in the left-right direction. Two convection heaters 26 may be installed to be spaced apart from each other in the vertical direction. The convection heater 26 may include a casing 27, a fan 28, and a heating unit 29. The casing 27 may have a roughly oval shallow dish shape when viewed from the front. The casing 27 may be attached to the rear surface of the case 10 with an opening facing the rear.

The casing 27 protrudes into the heating chamber 12 to form an accommodation portion 30 between the casing 27 and the rear surface of the case 10. A suction hole 31 that is open toward the front is defined in a central portion of the casing 27. A vent 33 is formed on a sidewall 32 of the casing 27. The fan 28 is accommodated in the accommodation portion 30 of the casing 27 and disposed behind the suction hole 31. The fan 28 may be a centrifugal fan, for example.

The heating unit 29 is installed inside the casing 27 to surround the fan 28. The heating unit 29 may include a heating wire that generates heat by supplying of an electric current, for example. The convection heater 26 rotates the fan 28 to suck in air in the heating chamber 12 through the suction hole 31 into the casing 27 and flow it to the outer circumference of the fan 28, and discharge air heated by the heating unit 29 into the heating chamber 12 through the vent 33. As such, the air in the heating chamber 12 is circulated, and heat is convected inside the heating chamber 12.

The output of the heating unit 20 is adjustable. The output of the heating unit 20 depends on the number and outputs of heaters in operation among the plurality of heaters, e.g., the upper heater 22, the lower heater 24, and the convection heater 26. In an embodiment, when the plurality of heaters has the same output, the output of the heating unit 20 increases as the number of heaters in operation state among the plurality of heaters increases, for example. In addition, as the output of a heater in operation among the plurality of heaters increases, the output of the heating unit 20 increases.

In addition, each of the plurality of heaters included in the heating unit 20, e.g., the upper heater 22, the lower heater 24, and the convection heater 26, may be switched between a continuous operation state in which the heater operates continuously, and an intermittent operation state in which the heater operates intermittently. The proportion of the operation time for an operation cycle of each of the plurality of heaters may be changed. In an embodiment, when the upper heater 22 is switched from the continuous operation state to the intermittent operation state, the output of the upper heater 22 decreases, for example. In addition, when the proportion of the operation time for the operation cycle of the upper heater 22 in the intermittent operation state decreases, the output of the upper heater 22 decreases.

An exhaust mechanism 35 is a mechanism that exhausts air in the heating chamber 12 to the outside. The exhaust mechanism 35 may include an exhaust portion 36 and an exhaust fan 38, and an exhaust opening 37 may be defined in the exhaust mechanism 35. The exhaust portion 36 is a portion that enables communication between the heating chamber 12 and the exhaust opening 37. The exhaust portion 36 may be provided at approximately a center position of the upper surface of the inner housing 10b of the case 10. The exhaust opening 37 may form a part of the ventilation flow path 13. The exhaust opening 37 may be provided across an upper portion, a rear portion, and a lower portion of the case 10. An exhaust port 39 is formed on a lower front surface of the case 10. When the exhaust fan 38 is driven, a flow of air is generated in the ventilation flow path 13.

The exhaust fan 38 is disposed in the exhaust opening 37 and at an upper rear portion of the case 10. The exhaust fan 38 may be a cross-flow fan, for example. The exhaust fan 38 sucks in air in the heating chamber 12 through the exhaust portion 36 into the exhaust opening 37, flows it through the exhaust opening 37, and discharges it to the outside through the exhaust port 39. The exhaust fan 38 also functions as a cooling fan that generates cooling wind to cool the control unit 90 and the food ingredient temperature detection unit 40. The cooling wind is formed by air flowing into the ventilation flow path 13 through intake ports 15 (refer to FIGS. 2 and 3) formed on an upper side surface of the case 10. The air forming the cooling wind flows through the exhaust opening 37 together with air in the heating chamber 12, and is then discharged to the outside through the exhaust port 39.

The food ingredient temperature detection unit 40 detects the internal temperature of the food ingredients F. In an embodiment, the food ingredient temperature detection unit 40 of the illustrated embodiment detects the surface temperature of the food ingredients F in a contactless manner (i.e., detecting the surface temperature of the food ingredients F without contacting the food ingredients F), for example. The food ingredient temperature detection unit 40 may include an infrared sensor, for example. The food ingredient temperature detection unit 40 is installed above the heating chamber 12, for example. The food ingredient temperature detection unit 40 scans approximately the entirety of the upper surface of the tray 18, and detects the heat distribution of a target area including the food ingredients F. A result of detection by the food ingredient temperature detection unit 40 (data representing the surface temperature of the target area including the food ingredients F) is output to the control unit 90.

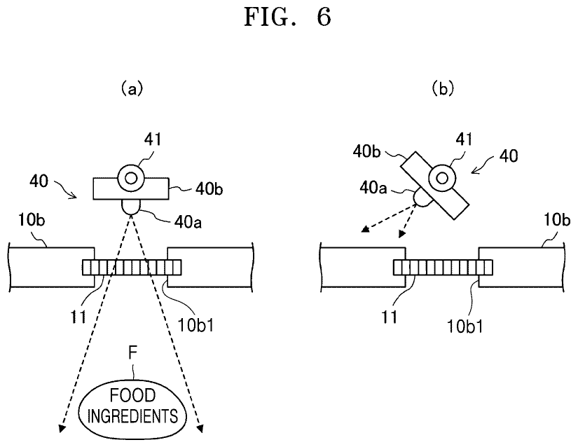

FIG. 6 is a schematic diagram of an embodiment of the food ingredient temperature detection unit 40 according to the disclosure. Referring to FIG. 6, the food ingredient temperature detection unit 40 detects the surface temperature of the food ingredients F through a through hole 10b1 of the inner housing 10b. In order to prevent the food ingredient temperature detection unit 40 from being exposed to relatively high heat when the inside of the heating chamber 12 becomes relatively high temperature due to the operation of the plurality of heaters, a window member 11 is disposed between the food ingredient temperature detection unit 40 and the heating chamber 12. In an embodiment, the window member 11 may be disposed in the through hole 10b1 of the inner housing 10b, for example. The food ingredient temperature detection unit 40 may be installed in the ventilation flow path 13 through which cooling wind flows. The window member 11 may include or consist of a material that has heat resistance to a temperature of 300° C. or higher and is transparent to infrared rays in a temperature range of 0° C. to 200° C., such as calcium fluoride or silicon. The thickness of the window member 11 may be about 1 millimeter (mm), and the dimension of the surface opposite to the food ingredient temperature detection unit 40 may be about 2 centimeters (cm) multiplied by 3 cm, for example. In an embodiment, in a case in which the inner housing 10b includes or consists of iron, the window member 11 may be disposed (e.g., mounted) on the inner housing 10b by a stainless steel holder, for example.

The food ingredient temperature detection unit 40 may include a detection element 40a such as a thermopile that mainly detects infrared rays, and a support 40b that supports the detection element 40a. A detection circuit or a microcomputer for converting the detected infrared rays into temperature data may be installed in the support 40b. The food ingredient temperature detection unit 40 may include a plurality of detection elements 40a. The detection element 40a may have a field of view (the range between two dotted arrows in FIG. 6), which is a detection range.

In an embodiment, the heating cooker 5 may include a rotation mechanism 41 that rotates the food ingredient temperature detection unit 40. The rotation mechanism 41 may include a motor and a rotation shaft, for example. The support 40b is disposed (e.g., mounted) on the rotation shaft of the rotation mechanism 41, and the food ingredient temperature detection unit 40 may be rotated by driving of the motor. During heating of the food ingredients F, the rotation mechanism 41 may rotate the food ingredient temperature detection unit 40 to at least a first rotation angle (the state illustrated in (a) of FIG. 6) and a second rotation angle (the state illustrated in (b) of FIG. 6). In other words, the control unit 90 may control the rotation mechanism 41 to rotate the food ingredient temperature detection unit 40 to at least the first rotation angle and the second rotation angle during heating of the food ingredients F. At the first rotation angle, the food ingredient temperature detection unit 40 detects the temperature (surface temperature) of the food ingredients F in the heating chamber 12 through the window member 11. In other words, the first rotation angle is a rotation angle when the food ingredient temperature detection unit 40 is in a position where it may measure the surface temperature of the food ingredients F in the heating chamber 12 through the window member 11. Here, a measured value of the surface temperature of the food ingredients F detected by the food ingredient temperature detection unit 40 at the first rotation angle is affected by the amount of radiation or infrared transmittance variation due to the temperature of the window member 11 itself. At the second rotation angle, the food ingredient temperature detection unit 40 detects the temperature of a peripheral portion of the window member 11, e.g., the inner housing 10b that serves as a maintenance mechanism for the window member 11. In other words, the second rotation angle is a rotation angle when the food ingredient temperature detection unit 40 does not include the window member 11 in its field of view and is in a position where it may measure the temperature of only a support mechanism supporting the window member 11. Data regarding the surface temperature of the food ingredients F and data regarding the temperature of the peripheral portion of the window member 11 both detected by the food ingredient temperature detection unit 40 are output to the control unit 90.

The first rotation angle may vary depending on at least one of the size and position of the food ingredients F. In addition, a plurality of different angles may be set as first rotation angles. In an embodiment, by rotating the food ingredient temperature detection unit 40 by the rotation mechanism 41 until the window member 11 is out of the field of view of the food ingredient temperature detection unit 40, the heating chamber 12 may be thoroughly observed as much as possible by the food ingredient temperature detection unit 40. Thus, the surface temperature of the food ingredients F may be detected without being affected by the size or position of the food ingredients F within the heating chamber 12.

In addition, the angular position of the food ingredient temperature detection unit 40 may be set to the second rotation angle in an initial state by the rotation mechanism 41. In other words, the control unit 90 may control the rotation mechanism 41 to set the food ingredient temperature detection unit 40 to be at the second rotation angle in the initial state. Accordingly, the temperature of the window member 11 may be accurately estimated in the initial state before heating.

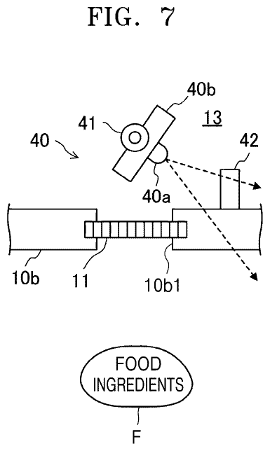

FIG. 7 is a schematic diagram of an embodiment of the food ingredient temperature detection unit 40 according to the disclosure. Referring to FIG. 7, the rotation mechanism 41 may rotate the food ingredient temperature detection unit 40 to a third rotation angle that is different from the first and second rotation angles, for example. In other words, the control unit 90 may control the rotation mechanism 41 to rotate the food ingredient temperature detection unit 40 to the third rotation angle. At the third rotation angle, the food ingredient temperature detection unit 40 may detect the temperature of a peripheral member 42. The peripheral member 42 may be formed along an outer side of the heating chamber 12, and may be installed inside the ventilation flow path 13 through which cooling wind flows. The food ingredient temperature detection unit 40 may be disposed in the ventilation flow path 13. The peripheral member 42 may be installed on the side of the ventilation flow path 13 of the inner housing 10b, that is, on the outside of the heating chamber 12. The peripheral member 42 may include or consist of resin, for example. As such, because temperature information of the ventilation flow path 13 may be obtained, cooling of the ventilation flow path 13 may be accurately controlled to protect the food ingredient temperature detection unit 40. That is, the control unit 90 may control the exhaust fan 38 based on the temperature of the peripheral member 42 detected by the food ingredient temperature detection unit 40. In this case, the temperature of the peripheral member 42 may also be detected as the temperature of the peripheral portion of the window member 11.

The three-dimensional measurement unit 46 obtains three-dimensional data representing the three-dimensional shape of the food ingredients F by measuring the three-dimensional shape of the food ingredients F placed in the heating chamber 12. In detail, the three-dimensional data may include three-dimensional coordinates representing the three-dimensional shape of the food ingredients F. In an embodiment, the three-dimensional measurement unit 46 may include a time-of-flight (TOF) camera, a stereo camera, or the like, for example. A result of measurement (three-dimensional data representing the three-dimensional shape of the food ingredients) by the three-dimensional measurement unit 46 is output to the control unit 90.

The in-chamber temperature detection unit 48 detects the internal temperature of the heating chamber 12. The in-chamber temperature detection unit 48 is installed inside the heating chamber 12. Strictly speaking, the in-chamber temperature detection unit 48 detects the temperature of air at the installation position of the in-chamber temperature detection unit 48 within the heating chamber 12. The in-chamber temperature detection unit 48 may include a known temperature sensor, such as a thermistor. A result of detection by the in-chamber temperature detection unit 48 (in-chamber temperature data representing the internal temperature of the heating chamber 12) is output to the control unit 90.

The photographing unit 50 obtains a captured image of the inside of the heating chamber 12 including the food ingredients F by photographing the inside of the heating chamber 12. In an embodiment, the photographing unit 50 may include a charge-coupled device (CCD) camera, a complementary metal-oxide-semiconductor (CMOS) camera, or the like, for example. The photographing unit 50 may also function as a smoke detector. The smoke detector detects smoke in the heating chamber 12.

The photographing unit 50 may be disposed at an upper portion of the left or right side of the case 10 (an upper left side in the examples illustrated in FIGS. 3 and 4) and at the center in the front-rear direction, such that the food ingredients F in the heating chamber 12 are included in the angle of view. The photographing unit 50 in the example includes one camera. The photographing unit 50 may include a plurality of cameras configured to photograph the inside of the heating chamber 12 from different viewpoints. A result (image data) of photographing by the photographing unit 50 is output to the control unit 90.

The display unit 62 and the manipulation unit 64 may be installed above the opening of the heating chamber 12 in the form of a control panel 60. The control panel 60 may be implemented as a display device with a touch panel attached thereto, for example. The display unit 62 may be a screen of a display device constituting the control panel 60. The manipulation unit 64 may be implemented by a touch panel. Of course, the manipulation unit 64 may include a physical manipulation button, a dial switch, or the like.

The display unit 62 displays information about heat cooking. In embodiments, information displayed on the display unit 62 may include a heat cooking operation mode, the output level of the heating unit 20, a time desired for heat cooking, the surface temperature of the food ingredients F, or the like. The display unit 62 may also display a captured image. A manipulation regarding heat cooking may be input from the user through the manipulation unit 64. Heat cooking setting information, heat cooking start and stop commands, or the like may be input through a touch manipulation on the control panel 60 by the user. Information (setting data regarding heating cooking) input through the control panel 60 is output to the control unit 90.

The memory unit 70 stores various types of information. The memory unit 70 may include a hard disk drive (HDD), a solid-state drive (SSD), a flash memory installed on a board, a universal serial bus (USB) memory, or a secure digital (SD) card, for example. The memory unit 70 is embedded in the heating cooker 5. The memory unit 70 may be integrated with the control unit 90, which will be described below, or may be implemented by an external memory unit installed outside the case 10. A food ingredient image (an image obtained by photographing the food ingredients F) prepared for each type of the food ingredients F may be stored in the memory unit 70.

The memory unit 70 may also store a heat cooking condition prepared for each combination of types and sizes of the food ingredients F. In an embodiment, the size of the food ingredients F may be any one of the thickness, volume, surface area, and weight of the food ingredients F, or a combination of at least two thereof, for example. The size of the food ingredients F may be obtained by calculation based on an image of the food ingredients F. The heat cooking condition is a condition for finishing cooking of the food ingredients F with an appropriate texture and taste in a process of heat-cooking the food ingredients F.

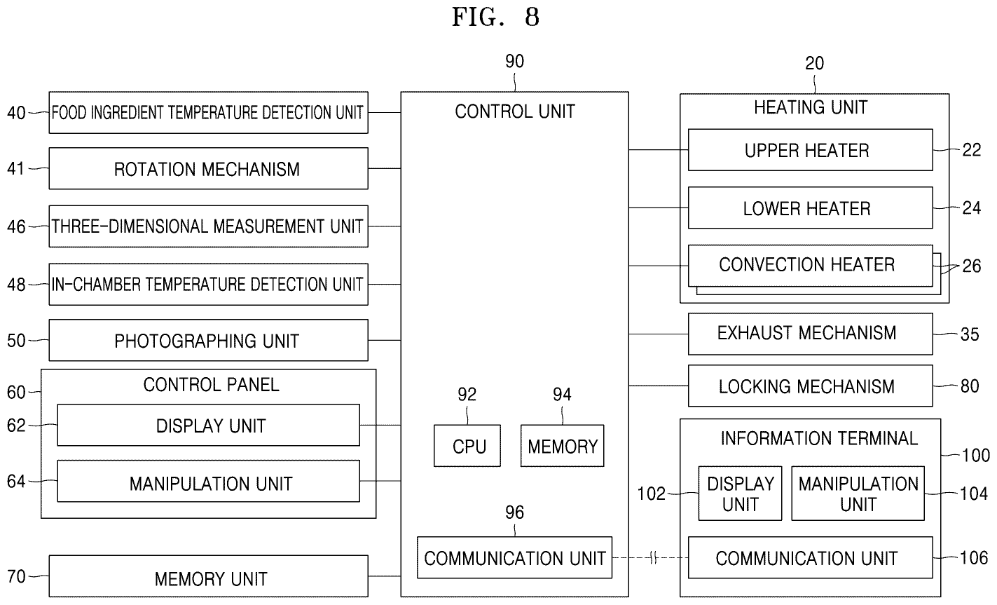

The control unit 90 controls the overall operation of the heating cooker 5. FIG. 8 is a block diagram illustrating an embodiment of the control unit 90 and related components thereof, according to the disclosure. As illustrated in FIG. 8, the control unit 90 is communicatively and electrically connected to the heating unit 20, the exhaust mechanism 35 (the exhaust fan 38), the food ingredient temperature detection unit 40, the rotation mechanism 41, the three-dimensional measurement unit 46, the in-chamber temperature detection unit 48, the photographing unit 50, the display unit 62, the manipulation unit 64, the memory unit 70, and the locking mechanism 80. The control unit 90 may be a controller based on a known microcomputer.

The control unit 90 may include a processor, e.g., a central processing unit (CPU) 92, and a memory 94. The memory 94 stores various programs and data. The CPU 92 executes a program read from the memory 94. The control unit 90 may include a communication unit 96. The communication unit 96 may have a communication function using a wireless local area network (LAN), such as wireless fidelity (WiFi), or a communication function according to a short-range wireless communication standard, such as Bluetooth® (registered trademark).

The control unit 90 executes a program stored in the memory 94 to control the heating unit 20 based on setting data regarding heat cooking that is input through the control panel 60, and various pieces of data input from the food ingredient temperature detection unit 40, the three-dimensional measurement unit 46, the in-chamber temperature detection unit 48, and the photographing unit 50. In an embodiment, the control unit 90 may control the upper heater 22, the lower heater 24, and the convection heater 26 according to a heat cooking condition depending on the type of the food ingredients F placed in the heating chamber 12, for example.

The control unit 90 may rotate the food ingredient temperature detection unit 40 to at least the first rotation angle (refer to (a) of FIG. 6) and the second rotation angle (refer to (b) of FIG. 6) through the rotation mechanism 41. Of course, the control unit 90 may also rotate the food ingredient temperature detection unit 40 to the first rotation angle (refer to (a) of FIG. 6), the second rotation angle (refer to (b) of FIG. 6), and the third rotation angle (refer to FIG. 7), through the rotation mechanism 41.

The control unit 90 may obtain temperature data regarding the peripheral portion of the window member 11 that is output from the food ingredient temperature detection unit 40, and estimate the temperature of the window member 11 based on the temperature of the peripheral portion of the window member 11. The control unit 90 may estimate the temperature of the window member 11 from the temperature of the peripheral portion of the window member 11 by a coefficient calculated in advance through experiment, or the like, or may use the temperature of the peripheral portion of the window member 11 as the temperature of the window member 11.

The control unit 90 obtains the surface temperature data regarding the food ingredients F that is output from the food ingredient temperature detection unit 40, and corrects the surface temperature of the food ingredients F based on the estimated temperature of the window member 11. As such, the influence of the amount of radiation or infrared transmittance variation due to the temperature of the window member 11 itself may be removed from the measured value of the surface temperature of the food ingredients F. The corrected value for the surface temperature of the food ingredients F may be calculated by following Calculation Formula, for example.

$$< Calculation Formula >$$

$$( Corrected value for surface temperature of food ingredients F ) = ( Measured value of surface temperature of food ingredients F ) - ( Estimated temperature of window member 11 ) \times ( Weighting factor )$$

Here, the weighting factor is a coefficient for calculating an error due to the temperature of the window member 11. In an embodiment, weighting factors may be calculated in advance by processing experimental results under various conditions by a statistical method, and the weighting factors may be stored in the memory unit 70 in the form of a correction table, for example. The control unit 90 may read and use a weighting factor from the correction table as desired.

The control unit 90 controls the display unit 62 to display the corrected value for the surface temperature of the food ingredients F. When the communication unit 96 receives a request command from the information terminal 100, the communication unit 96 transmits corrected value data for the surface temperature of the food ingredients F to the information terminal 100.

The information terminal 100 illustrated in FIG. 1 is a portable mobile device with a communication function. The information terminal 100 is an embodiment of an external device. As the information terminal 100, a relatively small multifunctional mobile phone referred to as a smart phone may be used, for example. As illustrated in FIG. 8, the information terminal 100 may include a display unit 102, a manipulation unit 104, and a communication unit 106. The display unit 102 and the manipulation unit 104 may be implemented as a display device with a touch panel attached thereto. The display unit 102 may be a screen of the display device, and the manipulation unit 104 may be the touch panel.

The communication unit 106 is an interface for communicating with other devices. The communication unit 106 communicates with an external network N (refer to FIG. 1), which is a wide area network, such as the Internet. The communication unit 106 may have a communication function using a wireless LAN such as WiFi, or a communication function according to a mobile communication standard such as long-term evolution (LTE). As particular application software is installed in the information terminal 100, communication with the heating cooker 5 through the external network N may be established.

In an embodiment, in the heating cooker 5 of the illustrated embodiment, the communication unit 96 provided in the control unit 90 transmits corrected value data for the surface temperature of the food ingredients F to the information terminal 100, for example. When the information terminal 100 displays the corrected value for the surface temperature of the food ingredients F on the display unit 102 based on the received corrected value data, the user, even when away from the heating cooker 5, may check the cooking state of the food ingredients F in the heating cooker 5 through the information terminal 100.

By a manipulation input from the user through the manipulation unit 104 of the information terminal 100, a request command for corrected value data for the surface temperature of the food ingredients F may be transmitted to the heating cooker 5 by a function of the communication unit 106. In addition, the information terminal 100 receives, through the communication unit 106, the corrected value data for the surface temperature of the food ingredients F transmitted from the heating cooker 5. The display unit 102 of the information terminal 100 displays the corrected value for the surface temperature of the food ingredients F based on the received corrected value data by a function of the application software.

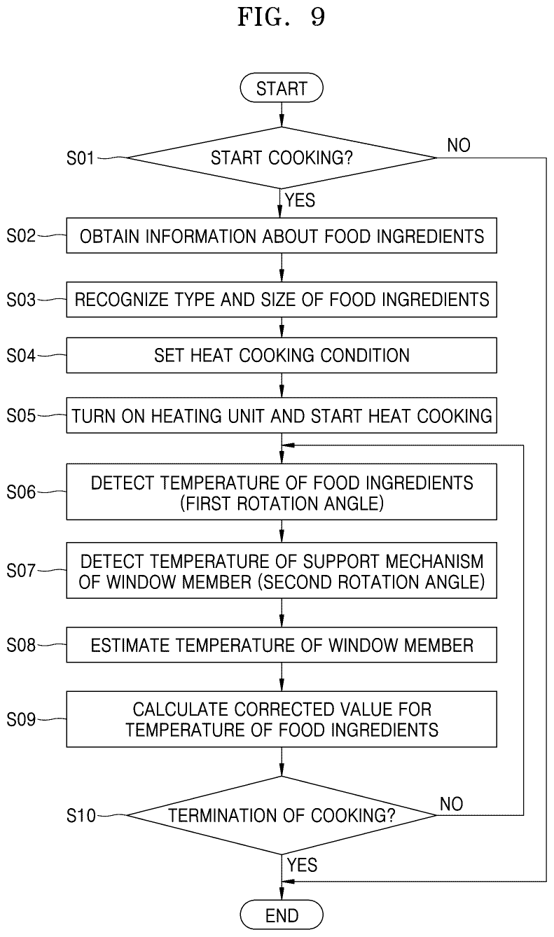

For heat cooking of the food ingredients F using the heating cooker 5, the food ingredients F are first put into the heating chamber 12. Then, a manipulation for setting a cooking method for the food ingredients F is input through the control panel 60. Then, a manipulation for instructing to start heat cooking is input through the control panel 60. Accordingly, the heating cooker 5 automatically performs heat cooking of the food ingredients F placed in the heating chamber 12. FIG. 9 is a flowchart of heating control according to the disclosure. An embodiment of heating control will be described with reference to FIG. 9.

As illustrated in FIG. 9, first, the control unit 90 determines whether a manipulation for instructing to start heat cooking has been input from a user (operation S01), for example. Whether a manipulation for instructing to start heat cooking has been input is determined based on a manipulation through the control panel 60. When the control unit 90 determines that a manipulation for instructing to start heat cooking has not been input (‘NO’ in operation S01), the control unit 90 terminates the process without starting heat cooking.

When the control unit 90 determines that a manipulation for instructing to start heat cooking of the food ingredients F has been input (‘YES’ in operation S01), the control unit 90 reads various pieces of data input from the food ingredient temperature detection unit 40, the three-dimensional measurement unit 46, the in-chamber temperature detection unit 48, and the photographing unit 50 (operation S02). Then, the control unit 90 recognizes the type and size of the food ingredients F based on three-dimensional data regarding the food ingredients input from the three-dimensional measurement unit 46, and image data input from the photographing unit 50 (operation S03).

When the control unit 90 recognizes the type and size of the food ingredients F, the control unit 90 sets a heat cooking condition for the food ingredients F based on the type and size of the food ingredients F (operation S04). Setting of the heat cooking condition for the food ingredients F is performed by selecting a heat cooking condition suitable for the type and size of the food ingredients F from among a plurality of heat cooking conditions stored in the memory unit 70. When a cooking finish state for the food ingredients F is input through the control panel 60, the heat cooking condition is selected considering the cooking finish state. Then, the control unit 90 turns on the heating unit 20 according to the set heat cooking condition to start heat cooking of the food ingredients F (operation S05).

When the heat cooking is started, the control unit 90 rotates the food ingredient temperature detection unit 40 to a first rotation angle (refer to (a) of FIG. 6) by the rotation mechanism 41. The food ingredient temperature detection unit 40 detects the surface temperature of the food ingredients F in the heating chamber 12 through the window member 11, at the first rotation angle, and outputs a result of the detection to the control unit 90 (operation S06). Here, because infrared rays are generated or the infrared transmittance changes due to heat generated from the window member 11 itself, an error may occur in the surface temperature of the food ingredients F detected at the first rotation angle.

After detecting the surface temperature of the food ingredients F at the first rotation angle, the control unit 90 rotates the food ingredient temperature detection unit 40 to a second rotation angle (refer to (b) of FIG. 6) by the rotation mechanism 41. The food ingredient temperature detection unit 40 detects the temperature of a peripheral portion of the window member 11 (e.g., the inner housing 10b that is a support mechanism of the window member 11) at the second rotation angle, and outputs a result of the detection to the control unit 90 (operation S07).

Then, the control unit 90 estimates the temperature of the window member 11 based on temperature data regarding the peripheral portion of the window member 11 obtained from the food ingredient temperature detection unit 40 (operation S08). Of course, operations S07 and S08 may be performed before operation S06.

Then, the control unit 90 calculates a corrected value for the surface temperature of the food ingredients F by correcting the surface temperature of the food ingredients F obtained from the food ingredient temperature detection unit 40, based on the estimated temperature of the window member 11 (operation S09). The control unit 90 displays the calculated corrected value for the surface temperature of the food ingredients F, through the display unit 62. When the communication unit 96 receives a request command from the information terminal 100, the control unit 90 transmits corrected value data for the surface temperature of the food ingredients F to the information terminal 100, and the information terminal 100 displays the received corrected value for the surface temperature of the food ingredients F on the display unit 102.

During the heat cooking of the food ingredients F, the control unit 90 estimates and monitors the internal temperature of the food ingredients F based on the corrected value for the surface temperature of the food ingredients F. The control unit 90 heats the food ingredients F by driving at least one of the upper heater 22, the lower heater 24, and the convection heater 26 such that the internal temperature of the food ingredients F changes according to a temperature profile included in the heat cooking condition. Here, the exhaust fan 38 is driven to cool the control unit 90 and simultaneously exhaust air in the heating chamber 12.

The control unit 90 determines whether a condition for termination of cooking has been satisfied whether the internal temperature of the food ingredients F has reached a target temperature (operation S10), for example. When the condition for termination of cooking is not satisfied, the control unit 90 repeats operations S06 to S09 at a preset timing. On the contrary, when the condition for termination of cooking is satisfied, the control unit 90 stops the heating operation of heating the food ingredients F by the heating unit 20, and completes the heat cooking. When the heat cooking of the food ingredients F is completed, the control unit 90 may notify the user of the completion of the heat cooking of the food ingredients F by turning on a lamp installed as part of the display unit 62 on the control panel 60 or by outputting a sound by a sound generator installed in the heating cooker 5.

The heating cooker 5 in an embodiment of the disclosure includes the case 10 in which the heating chamber 12 in which the food ingredients F are placed is formed, the heating unit 20 configured to heat the inside of the heating chamber 12, the control unit 90 configured to control the heating unit 20, the food ingredient temperature detection unit 40 configured to detect, in a contactless manner, the surface temperature of the food ingredients F being cooked in the heating chamber 12, and the window member 11 disposed between the food ingredient temperature detection unit 40 and the heating chamber 12. The control unit 90 corrects a surface temperature of the food ingredients F detected by the food ingredient temperature detection unit 40, based on the temperature of the window member 11.

Because the window member 11 is disposed between the food ingredient temperature detection unit 40 configured to detect the surface temperature of the food ingredients F in a contactless manner, and the heating chamber 12, the food ingredient temperature detection unit 40 may be prevented from being exposed to relatively high heat even when the inside of the heating chamber 12 becomes relatively high temperature due to heating by a heater. In addition, the food ingredient temperature detection unit 40 may be prevented from being contaminated by soot or the like formed during a cooking process. In addition, because a surface temperature of the food ingredients F detected by the food ingredient temperature detection unit 40 is corrected by the temperature of the window member 11, in other words, because the influence of the amount of radiation or infrared transmittance variation due to the temperature of the window member 11 itself is removed from a measured value of the surface temperature of the food ingredients F, the surface temperature of the food ingredients F may be accurately detected in a contactless manner. Thus, contactless detection of the surface temperature of the food ingredients F is possible even in a heating cooker 5 where the internal temperature of the heating chamber 12 rises, such as an oven. In addition, by displaying the surface temperature of the food ingredients F being cooked, on the display unit 62 provided in the heating cooker 5 or the display unit 102 of the information terminal 100, the user may check the progress of cooking in real time. In addition, even when there is concern about a cooking finish state or scorching of the food ingredients F, the user may check the cooking state to see when the temperature of the food ingredients F has risen too much, without opening the door 14 of the heating chamber 12.

The food ingredient temperature detection unit 40 may be rotated by the rotation mechanism 41. The rotation mechanism 41 rotates the food ingredient temperature detection unit 40 to at least the first rotation angle and the second rotation angle during heating of the food ingredients F. At the first rotation angle, the food ingredient temperature detection unit 40 detects the temperature of the food ingredients F in the heating chamber 12 through the window member 11. At the second rotation angle, the food ingredient temperature detection unit 40 detects the temperature of the peripheral portion of the window member 11. The control unit 90 estimates the temperature of the window member 11 based on the temperature of the peripheral portion. With this configuration, the temperature of the window member 11 may be estimated by the food ingredient temperature detection unit 40, and thus, a surface temperature of the food ingredients F may be corrected even when the temperature of the window member 11 cannot be directly detected. In addition, the manufacturing cost of the heating cooker 5 may be reduced compared to when separately installing a contact-type sensor or a detection circuit for directly detecting the temperature of the window member 11.

The first rotation angle may vary depending on at least one of the size and position of the food ingredients F. In this way, the surface temperature of the food ingredients F may be detected more accurately.

In the initial state, the angular position of the food ingredient temperature detection unit 40 may be set to the second rotation angle by the rotation mechanism 41. In this way, the temperature of the window member 11 in the initial state may be accurately estimated.

The food ingredient temperature detection unit 40 may be rotated to the third rotation angle by the rotation mechanism 41. At the third rotation angle, the food ingredient temperature detection unit 40 may detect the temperature of the peripheral member 42 other than the window member 11 installed outside the heating chamber 12. In this way, information about the temperature of a space where the food ingredient temperature detection unit 40 is placed (the ventilation flow path 13) may be obtained, and thus, the food ingredient temperature detection unit 40 may be protected by accurately controlling cooling of the space.

The peripheral portion of the window member 11, of which the temperature is detected by the food ingredient temperature detection unit 40 at the second rotation angle, may be a support mechanism (the inner housing 10b) of the window member 11, or a metal member installed in the window member 11 or the support mechanism. In this way, the temperature of the window member 11, which cannot be detected in a contactless manner, may be estimated based on a temperature detected by the food ingredient temperature detection unit 40 at the second rotation angle.

The control unit 90 may transmit corrected value data for the surface temperature of the food ingredients F to the information terminal 100 by the communication unit 96. In this way, even when the user is away from the heating cooker 5, the user may check the cooking state of the food ingredients F in the heating chamber 12 based on data received through the information terminal 100. The information terminal 100 is a portable mobile device and thus has relatively high convenience.

The heating cooker 5 may include the display unit 62, and a corrected value for the surface temperature of the food ingredients F may be displayed on the display unit 62. In this way, the user may check the cooking state of the food ingredients F in the heating chamber 12 by viewing the display unit 62.

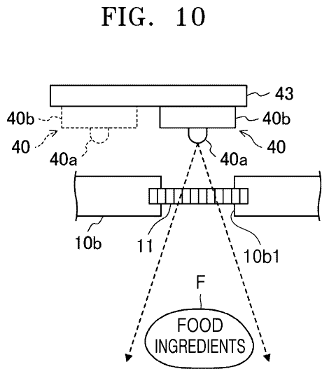

FIG. 10 is a schematic diagram of an embodiment of the food ingredient temperature detection unit 40 according to the disclosure. The illustrated embodiment is different from the embodiments illustrated in FIGS. 6 and 7, in that it employs a moving mechanism 43 that moves the food ingredient temperature detection unit 40 in a straight line in a horizontal direction, for example, instead of the rotation mechanism 41 illustrated in FIGS. 6 and 7. The moving mechanism 43 may be implemented by a linkage or a crank, for example. The moving mechanism 43 moves the food ingredient temperature detection unit 40 to at least a first position (the position indicated by a solid line in FIG. 10) and a second position (the position indicated by a dotted line in FIG. 10) during heating of the food ingredients F. In other words, the control unit 90 controls the moving mechanism 43 to move the food ingredient temperature detection unit 40 to at least the first position and the second position during heating of the food ingredients F. At the first position, the food ingredient temperature detection unit 40 detects the temperature of the food ingredients F in the heating chamber 12 through the window member 11. At the second position, the food ingredient temperature detection unit 40 detects the temperature of a peripheral portion of the window member 11, e.g., the support mechanism of the window member 11, e.g., the inner housing 10b. Data regarding the surface temperature of the food ingredients F and data regarding the temperature of the peripheral portion of the window member 11 both detected by the food ingredient temperature detection unit 40 are output to the control unit 90. As in the above-described embodiments, the control unit 90 estimates the temperature of the window member 11 based on the temperature of the peripheral portion of the window member 11, and correct the surface temperature of the food ingredients F based on the estimated temperature of the window member 11.

According to this configuration, the same effects as the above-described embodiments may be obtained. That is, the temperature of the window member 11 may be estimated by the food ingredient temperature detection unit 40, and thus, a surface temperature of the food ingredients F may be corrected even when the temperature of the window member 11 cannot be directly detected. In addition, the manufacturing cost of the heating cooker 5 may be reduced compared to when separately installing a contact-type sensor or a detection circuit for directly detecting the temperature of the window member 11.

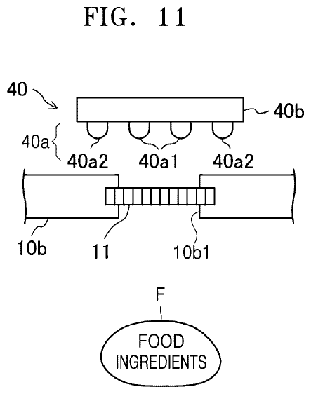

FIG. 11 is a schematic diagram of an embodiment of the food ingredient temperature detection unit 40 according to the disclosure. The illustrated embodiment is different from the above-described embodiments in that the rotation mechanism 41 illustrated in FIGS. 6 and 7 or the moving mechanism 43 illustrated in FIG. 10 is not installed, but instead, as illustrated in FIG. 11, the food ingredient temperature detection unit 40 includes, as the detection element 40a, at least one first detection element (first detection unit) 40a1, and at least one second detection element (second detection unit) 40a2. The first detection element 40a1 detects the temperature of the food ingredients F in the heating chamber 12 through the window member 11. In other words, the field of view (detection range) of the first detection element 40a1 includes the window member 11, and does not include the area outside the window member 11. The second detection element 40a2 detects the temperature of the peripheral portion of the window member 11. In other words, the field of view (detection range) of the second detection element 40a2 includes the peripheral portion of the window member 11 and does not include the window member 11. Data regarding the surface temperature of the food ingredients F and data regarding the temperature of the peripheral portion of the window member 11 both detected by the food ingredient temperature detection unit 40 are output to the control unit 90. As in the above-described embodiments, the control unit 90 estimates the temperature of the window member 11 based on the temperature of the peripheral portion of the window member 11, and correct the surface temperature of the food ingredients F based on the estimated temperature of the window member 11. The first detection element 40a1 and the second detection element 40a2 may be arranged one-dimensionally (linear arrangement), or may be arranged two-dimensionally (matrix-type arrangement).

According to this configuration, the same effects as the above-described embodiments may be obtained. That is, the temperature of the window member 11 may be estimated by the food ingredient temperature detection unit 40, and thus, a surface temperature of the food ingredients F may be corrected even when the temperature of the window member 11 cannot be directly detected. In addition, the manufacturing cost of the heating cooker 5 may be reduced compared to when separately installing a contact-type sensor or a detection circuit for directly detecting the temperature of the window member 11.

Because there is no need to provide the rotation mechanism 41 or the moving mechanism 43 for rotating or linearly moving the food ingredient temperature detection unit 40, the configuration of the heating cooker 5 may be simplified.

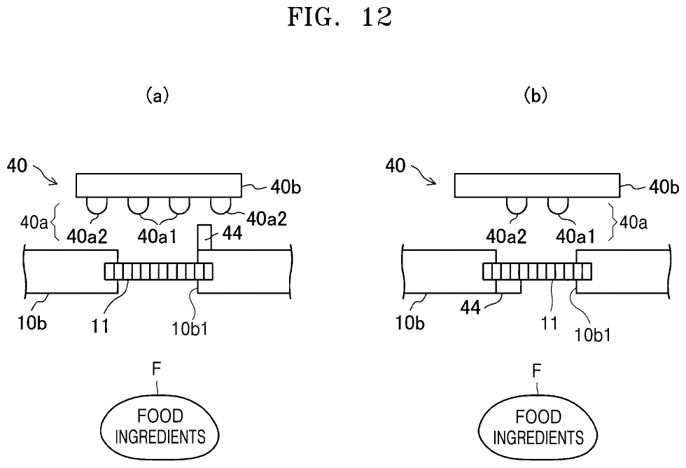

FIG. 12 is a schematic diagram of an embodiment of the food ingredient temperature detection unit 40 according to the disclosure. A metal member 44 may be provided in the support mechanism (the inner housing 10b) of the window member 11 as illustrated in (a) of FIG. 12, or in the window member 11 as illustrated in (b) of FIG. 12, the temperature of the metal member 44 may be detected as the temperature of the peripheral portion of the window member 11. In this case, the metal member 44 may be selected according to the material of the window member 11 or the like, such that the temperature of the window member 11 may be accurately estimated. In addition, it is possible to reduce the fields of view (detection ranges) of the first detection element 40a1 and the second detection element 40a2, and thus, the surface temperature of the food ingredients F and the temperature of the peripheral portion of the window member 11 may be accurately detected. In particular, in a case in which the metal member 44 is provided in the window member 11 as illustrated in (b) of FIG. 12, the window member 11 is included in the field of view of the second detection element 40a2, and thus, the number of first detection elements 40a1 and second detection elements 40a2 may be reduced.

In the embodiments illustrated in FIGS. 11 and 12, in a case in which a plurality of first detection elements 40a1 is provided, a temperature detected by the first detection element 40a1 having a field of view in the center of the inside of the heating chamber 12, or by the first detection element 40a1 having a field of view in an area where the food ingredients F occupy the largest area, among the plurality of first detection elements 40a1, may be used as the surface temperature of the food ingredients F. An area occupied of the food ingredients F may be calculated from analysis of a captured image obtained by the photographing unit 50.

In addition, in the embodiments illustrated in FIGS. 11 and 12, the rotation mechanism 41 or the moving mechanism 43 may be applied to rotate or move the food ingredient temperature detection unit 40. In this case, at the first rotation angle or the first position, for example, the food ingredient temperature detection unit 40 may be disposed such that the fields of view of all detection elements 40a include the window member 11, and at the second rotation angle or the second position, the food ingredient temperature detection unit 40 may be moved such that the fields of view of at least some detection elements 40a include the peripheral portion of the window member 11.

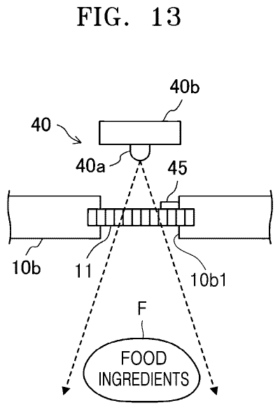

FIG. 13 is a schematic diagram of an embodiment of a window member temperature detection unit 45 according to the disclosure. The illustrated embodiment is different from the above-described embodiments illustrated in FIGS. 6 and 7, in that the window member temperature detection unit 45 configured to directly detect the temperature of the window member 11 is attached to the window member 11, without employing the rotation mechanism 41 or the moving mechanism 43. The window member temperature detection unit 45 may include a thermistor, for example. In this case, considering the relatively small size of the window member 11, a detection circuit or a microcomputer for converting an output of the thermistor into a temperature may be installed outside the window member 11, and connected to the window member temperature detection unit 45 through a wire.

Data regarding a surface temperature of the food ingredients F detected by the food ingredient temperature detection unit 40 is output to the control unit 90, and data regarding a temperature of the window member 11 detected by the window member temperature detection unit 45 is output to the control unit 90. The control unit 90 corrects the surface temperature of the food ingredients F based on the temperature of the window member 11.

Because the temperature of the window member 11 may be accurately detected, the surface temperature of the food ingredients F may be corrected with relatively high precision. In this way, an accurate value of the surface temperature of the food ingredients F may be obtained. In addition, because there is no need to provide the rotation mechanism 41 or the moving mechanism 43 for rotating or moving the food ingredient temperature detection unit 40, the structure of the heating cooker 5 may be simplified.

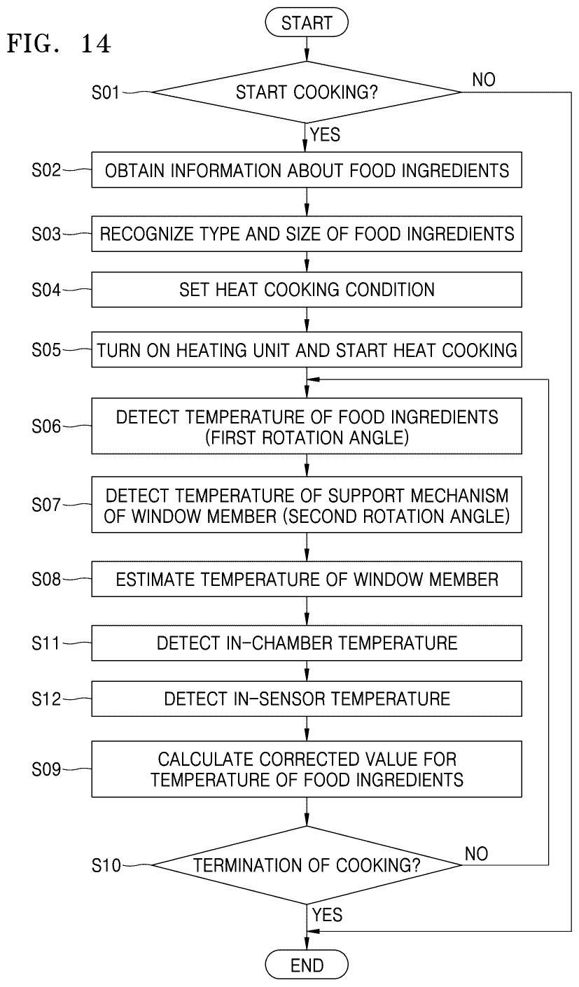

FIG. 14 is a flowchart of an embodiment of heating control according to the disclosure. Referring to FIG. 14, the heating control of the illustrated embodiment is different from an embodiment of heating control illustrated in FIG. 9, in that, detection of the internal temperature of the heating chamber 12 (hereinafter, also referred to as an in-chamber temperature) (operation S11) and detection of the internal temperature of the food ingredient temperature detection unit 40 (hereinafter, also referred to as an in-sensor temperature) (operation S12) are performed after starting the heat cooking (operation S05), and in operation S09, the control unit 90 calculates a corrected value for the surface temperature of the food ingredients F based on the in-chamber temperature and the in-sensor temperature, in addition to the estimated temperature of the window member 11.

The in-chamber temperature is detected by the in-chamber temperature detection unit 48 (refer to FIGS. 4 and 8). Data regarding the in-chamber temperature detected by the in-chamber temperature detection unit 48 is output to the control unit 90.

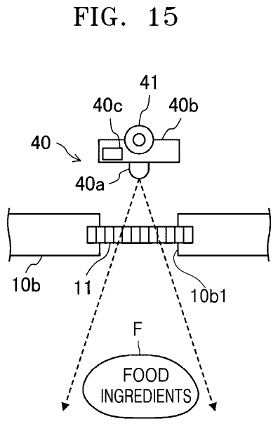

FIG. 15 is a schematic diagram of an embodiment of an in-sensor temperature detection unit 40c according to the disclosure. In an embodiment, an in-sensor temperature is detected by the in-sensor temperature detection unit 40c provided inside the food ingredient temperature detection unit 40 (e.g., the support 40b) as illustrated in FIG. 15, for example. The in-sensor temperature detection unit 40c may include a thermistor, for example. Data regarding the in-sensor temperature detected by the in-sensor temperature detection unit 40c is output to the control unit 90.

In the heating cooker 5, an error of a measured value of the surface temperature of the food ingredients F obtained by the food ingredient temperature detection unit 40 may increase due to the influence of infrared radiation from a source other than the food ingredients F or the like as the internal temperature of the heating chamber 12 increases. Error factors include, in addition to the radiant energy from the window member 11 considered in the above-described embodiments, radiant energy from the inside of the heating chamber 12 other than the food ingredients F, and temperature dependence of the food ingredient temperature detection unit 40 (the variation in a detection level due to temperature). The radiant energy from the inside of the heating chamber 12 may include radiant energy from a wall of the heating chamber 12 or radiant energy from the tray 18 on which the food ingredients F are placed.

In the illustrated embodiment, because the control unit 90 calculates a corrected value for a surface temperature of the food ingredients F based on an in-chamber temperature and an in-sensor temperature in addition to an estimated temperature of the window member 11, the surface temperature of the food ingredients F may be corrected with higher precision. A corrected value for a surface temperature of the food ingredients F may be calculated from Equation below, for example.

$$< Equation >$$

$$( Corrected value for surface temperature of food ingredients F ) = ( Measured value of surface temperature of food ingredients F ) - ( Estimated temperature of window member 11 ) \times ( Weighting factor α ) - ( In - chamber temperature ) \times ( Weighting factor β ) - ( In - sensor temperature ) \times ( Weighting factor γ )$$

The weighting factor a denotes a coefficient for calculating an error due to the temperature of the window member 11 when the in-chamber temperature and the in-sensor temperature are room temperature. The weighting factor β denotes a coefficient for calculating an error due to the in-chamber temperature when the in-sensor temperature and the temperature of the window member 11 are room temperature. The weighting factor y denotes a coefficient for calculating an error due to the in-sensor temperature when the in-chamber temperature and the temperature of the window member 11 are room temperature. These weighting factors may be obtained in advance by processing experimental results under various conditions by a statistical method, and stored as a correction table in the memory unit 70, for example, such that the control unit 90 may load each weighting factor from the correction table as desired.

When a measurement error due to the in-chamber temperature or the in-sensor temperature is sufficiently small, the control unit 90 may calculate a corrected value for the surface temperature of the food ingredients F by further applying only one of the in-chamber temperature and the in-sensor temperature, in addition to the estimated temperature of the window member 11.

In addition, the corrected value for the surface temperature of the food ingredients F may also be calculated based on the temperature dependence of the transmittance of the window member 11, the heating method of the heating unit 20, or the like, in addition to the in-chamber temperature and the in-sensor temperature, or instead of the in-chamber temperature and the in-sensor temperature. The heating method of the heating unit 20 includes various heating methods depending on the type of the food ingredients F or the amount of the food ingredients F, such as a heating method using hot air or a heating method using radiation, and in particular, the heating method using radiation has a relatively large influence on the amount of infrared radiation. When considering the heating method of the heating unit 20, a surface temperature of the food ingredients F may be corrected by estimating the influence of radiation within the heating chamber 12 based on the heating method and the in-chamber temperature, for example.

In the above-described embodiments, an example is described in which the food ingredient temperature detection unit 40 configured to measure the surface temperature of the food ingredients F in a contactless manner includes an infrared sensor, but the configuration of the food ingredient temperature detection unit 40 is not limited thereto. As a contactless temperature sensor used in the food ingredient temperature detection unit 40, other types of radiation thermometers, such as a total-radiation thermometer that measures heat energy in a wide wavelength band, may be used. In an alternative embodiment, the food ingredient temperature detection unit 40 may include a thermal imaging sensor, such as a thermography sensor capable of measuring the temperature distribution over a relatively large area.

In the above-described embodiments, the heating unit 20 includes a plurality of heaters, e.g., the upper heater 22, the lower heater 24, and the convection heater 26, but the structure of the heating unit 20 is not limited thereto. The heating unit 20 may include two heaters, e.g., the upper heater 22 and the convection heater 26, or the lower heater 24 and the convection heater 26, or the upper heater 22 and the lower heater 24. In addition, the heating unit 20 may include one heater.

In the above-described embodiments, the control unit 90 recognizes the type and size of the food ingredients F placed in the heating chamber 12 based on the three-dimensional data input from the three-dimensional measurement unit 46 and the image data input from the photographing unit 50, but the method of recognizing the type and size of the food ingredients F placed in the heating chamber 12 is not limited thereto. The heating cooker 5 may receive, through the control panel 60, a manipulation for specifying the type of the food ingredients F to be cooked. In addition, the heating cooker 5 may also receive, through the control panel 60, the size of the food ingredients F to be cooked.

In the above-described embodiments, the image of the food ingredients and the heat cooking condition are stored in the memory unit 70 embedded in the heating cooker 5, but the storage locations of the image of the food ingredients and the heat cooking condition are not limited thereto. The image of the food ingredients and the heat cooking condition may be stored in a cloud server on the Internet, and the control unit 90 may access the cloud server via the Internet to appropriately obtain the image of the food ingredients and the heat cooking condition.

In the above-described embodiments, an example is described in which the heating cooker 5 according to the disclosure is a convection oven, but the heating cooker 5 according to the disclosure is not limited thereto. The oven is merely one of embodiments of the heating cooker 5. The technology applied to the heating cooker 5 according to the disclosure may also be applied to other heating cookers, such as a grill attached to a stove, or a microwave oven.

A heating cooker according to a feature of the disclosure includes: a case 10 in which a heating chamber 12 in which food ingredients are placed is formed; a heating unit 20 configured to heat the inside of the heating chamber; a control unit 90 configured to control the heating unit; a food ingredient temperature detection unit 40 configured to detect a surface temperature of the food ingredients being cooked in the heating chamber, in a contactless manner; and a window member 11 disposed between the food ingredient temperature detection unit and the heating chamber. The control unit may be further configured to correct the surface temperature of the food ingredient detected by the food ingredient temperature detection unit, based on at least a temperature of the window member. According to this configuration, because the window member is disposed between the food ingredient temperature detection unit configured to detect the surface temperature of the food ingredients in a contactless manner, and the heating chamber, the food ingredient temperature detection unit may be prevented from being directly exposed to relatively high heat even when the inside of the heating chamber becomes relatively high temperature due to heating by a heater. In addition, the food ingredient temperature detection unit may be prevented from being contaminated by soot or the like formed during a cooking process. In addition, because a surface temperature of the food ingredients detected by the food ingredient temperature detection unit is corrected by the temperature of the window member, in other words, because the influence of the amount of radiation or infrared transmittance variation due to the temperature of the window member itself is removed from a measured value of the surface temperature of the food ingredients, the surface temperature of the food ingredients may be accurately detected in a contactless manner. Thus, contactless detection of the surface temperature of the food ingredients is possible even in a heating cooker where the internal temperature of a heating chamber rises, such as an oven. In addition, by displaying the surface temperature of the food ingredients being cooked, on a display unit provided in the heating cooker or on a portable terminal, a user may check the progress of cooking in real time. In addition, even when there is concern about a cooking finish state or scorching of the food ingredients, the user may check the cooking state to see when the temperature of the food ingredients has risen too much, without opening the door of the heating chamber.

In an embodiment, the heating cooker may further include a rotation mechanism 41 configured to rotate the food ingredient temperature detection unit. The control unit may be further configured to control the rotation mechanism to rotate the food ingredient temperature detection unit to at least a first rotation angle and a second rotation angle during heating of the food ingredients. The food ingredient temperature detection unit may be further configured to, at the first rotation angle, detect a temperature of the food ingredients in the heating chamber through the window member, and at the second rotation angle, detect a temperature of a peripheral portion of the window member. The control unit may be further configured to estimate the temperature of the window member based on the temperature of the peripheral portion. According to this configuration, the temperature of the window member may be estimated by the food ingredient temperature detection unit, and thus, a surface temperature of the food ingredients may be corrected even when the temperature of the window member cannot be directly detected. In addition, the manufacturing cost of the heating cooker may be reduced compared to when separately installing a contact-type sensor or a detection circuit for directly detecting the temperature of the window member.

In an embodiment, the first rotation angle may be variable depending on at least one of a size of the food ingredients and a position of the food ingredients within the heating chamber. Accordingly, the surface temperature of the food ingredients may be detected more accurately.

In an embodiment, the control unit may be further configured to control the rotation mechanism to set the food ingredient temperature detection unit to be at the second rotation angle in an initial state. Accordingly, the temperature of the window member in the initial state may be accurately estimated.

In an embodiment, the control unit may be further configured to control the rotation mechanism to rotate the food ingredient temperature detection unit to a third rotation angle, and the food ingredient temperature detection unit may be further configured to, at the third rotation angle, detect a temperature of a peripheral member 42 installed outside the heating chamber. In an embodiment, the heating cooker may further include a ventilation flow path 13 formed along an outer side of the heating chamber, and through which cooling wind flows. The peripheral member may be disposed in the ventilation flow path. The food ingredient temperature detection unit may be disposed in the ventilation flow path. In an embodiment, the heating cooker may further include an exhaust fan 38 configured to generate the cooling wind along the ventilation flow path. The control unit may be further configured to control the exhaust fan 38 based on a temperature of the peripheral member detected by the food ingredient temperature detection unit. According to this configuration, information about the temperature of a space where the food ingredient temperature detection unit is disposed may be obtained, and thus, cooling of the space may be accurately controlled to protect the food ingredient temperature detection unit.

In an embodiment, the heating cooker may further include a moving mechanism 43 configured to move the food ingredient temperature detection unit in a straight line. The control unit may be further configured to control the moving mechanism to move the food ingredient temperature detection unit to at least a first position and a second position during heating of the food ingredients. The food ingredient temperature detection unit may be further configured to, at the first position, detect a temperature of the food ingredients in the heating chamber through the window member, and at the second position, detect a temperature of a peripheral portion of the window member. The control unit may be further configured to estimate the temperature of the window member based on the temperature of the peripheral portion. According to this configuration, the temperature of the window member may be estimated by the food ingredient temperature detection unit, and thus, a surface temperature of the food ingredients may be corrected even when the temperature of the window member cannot be directly detected. In addition, the manufacturing cost of the heating cooker may be reduced compared to when separately installing a contact-type sensor or a detection circuit for directly detecting the temperature of the window member.

In an embodiment, the food ingredient temperature detection unit may include a first detection element 40a1 configured to detect a temperature of the food ingredients in the heating chamber through the window member, and a second detection element 40a2 configured to detect a temperature of a peripheral portion of the window member. The control unit may be further configured to estimate the temperature of the window member based on the temperature of the peripheral portion detected by the second detection element. According to this configuration, the temperature of the window member may be estimated by the food ingredient temperature detection unit, and thus, a surface temperature of the food ingredients may be corrected even when the temperature of the window member cannot be directly detected. In addition, the manufacturing cost of the heating cooker may be reduced compared to when separately installing a contact-type sensor or a detection circuit for directly detecting the temperature of the window member. In addition, because there is no need to provide a mechanism to rotate or move the food ingredient temperature detection unit, the configuration of the heating cooker may be simplified.

In an embodiment, the peripheral portion may include a support mechanism (e.g., an inner housing 10b) of the window member. In an embodiment, the peripheral portion may include a metal member 44 installed in one of the window member and a support mechanism of the window member. According to this configuration, the temperature of the window member may be estimated by detecting the temperature of the peripheral portion by the food ingredient temperature detection unit.

In an embodiment, the heating cooker may further include a window member temperature detection unit 45 attached to the window member and configured to directly detect the temperature of the window member. According to this configuration, the temperature of the window member may be accurately detected.

In an embodiment, the heating cooker may further include an in-chamber temperature detection unit 48 configured to detect an internal temperature of the heating chamber. The control unit may be further configured to correct the surface temperature of the food ingredients detected by the food ingredient temperature detection unit, based on at least the temperature of the window member and the internal temperature of the heating chamber. According to this configuration, the surface temperature of the food ingredients may be more accurately corrected by additionally using the internal temperature of the heating chamber.

In an embodiment, the heating cooker may further include an in-sensor temperature detection unit 40c configured to detect an internal temperature of the food ingredient temperature detection unit. The control unit may be further configured to correct the surface temperature of the food ingredients detected by the food ingredient temperature detection unit, based on at least the temperature of the window member and the internal temperature of the food ingredient temperature detection unit. According to this configuration, the surface temperature of the food ingredients may be more accurately corrected by additionally using the internal temperature of the food ingredient temperature detection unit.

Although the heating cooker of the disclosure have been described with the limited embodiments and the drawings, various modifications and changes may be made by those of skill in the art from the above description.

What is claimed is:

1. A heating cooker for cooking a food ingredient, the heating cooker comprising:
a case in which a heating chamber configured to accommodate the food ingredient is defined;
a heating unit configured to heat an inside of the heating chamber;
a control processor configured to control the heating unit;
a food ingredient temperature detection unit configured to detect, in a contactless manner, a surface temperature of the food ingredient being cooked in the heating chamber; and
a window member disposed between the food ingredient temperature detection unit and the heating chamber,
wherein the control processor is further configured to correct the surface temperature of the food ingredient detected by the food ingredient temperature detection unit, based on at least a temperature of the window member.

2. The heating cooker of claim 1, further comprising a rotation mechanism configured to rotate the food ingredient temperature detection unit,
wherein the control processor is further configured to control the rotation mechanism to rotate the food ingredient temperature detection unit to at least a first rotation angle and a second rotation angle during heating of the food ingredient,
the food ingredient temperature detection unit is further configured to, at the first rotation angle, detect the surface temperature of the food ingredient in the heating chamber through the window member, and at the second rotation angle, detect a temperature of a peripheral portion of the window member, and
the control processor is further configured to estimate the temperature of the window member based on the temperature of the peripheral portion.

3. The heating cooker of claim 2, wherein the first rotation angle is variable depending on at least one of a size of the food ingredient and a position of the food ingredient within the heating chamber.

4. The heating cooker of claim 2, wherein the control processor is further configured to control the rotation mechanism to set the food ingredient temperature detection unit to be at the second rotation angle in an initial state.

5. The heating cooker of claim 2, wherein the control processor is further configured to control the rotation mechanism to rotate the food ingredient temperature detection unit to a third rotation angle, and
the food ingredient temperature detection unit is further configured to, at the third rotation angle, detect a temperature of a peripheral member installed outside the heating chamber.

6. The heating cooker of claim 5, further comprising a ventilation flow path formed along an outer side of the heating chamber and through which cooling wind flows,
wherein the peripheral member is disposed in the ventilation flow path.

7. The heating cooker of claim 6, wherein the food ingredient temperature detection unit is disposed in the ventilation flow path.

8. The heating cooker of claim 5, further comprising a ventilation flow path and an exhaust fan configured to generate cooling wind along the ventilation flow path,
wherein the control processor is further configured to control the exhaust fan based on the temperature of the peripheral member detected by the food ingredient temperature detection unit.

9. The heating cooker of claim 1, further comprising a moving mechanism configured to move the food ingredient temperature detection unit in a straight line,
wherein the control processor is further configured to control the moving mechanism to move the food ingredient temperature detection unit to at least a first position and a second position during heating of the food ingredient,
the food ingredient temperature detection unit is further configured to, at the first position, detect the surface temperature of the food ingredient in the heating chamber through the window member, and at the second position, detect a temperature of a peripheral portion of the window member, and
the control processor is further configured to estimate the temperature of the window member based on the temperature of the peripheral portion.

10. The heating cooker of claim 1, wherein the food ingredient temperature detection unit comprises a first detection element configured to detect the surface temperature of the food ingredient in the heating chamber through the window member, and a second detection element configured to detect a temperature of a peripheral portion of the window member, and
the control processor is further configured to estimate the temperature of the window member based on the temperature of the peripheral portion detected by the second detection element.

11. The heating cooker of claim 2, wherein the peripheral portion comprises a support mechanism of the window member.

12. The heating cooker of claim 2, wherein the peripheral portion comprises a metal member installed in one of the window member and a support mechanism of the window member.

13. The heating cooker of claim 1, further comprising a window member temperature detection unit attached to the window member and configured to directly detect the temperature of the window member.

14. The heating cooker of claim 1, further comprising an in-chamber temperature detection unit configured to detect an internal temperature of the heating chamber,
wherein the control processor is further configured to correct the surface temperature of the food ingredient detected by the food ingredient temperature detection unit based on at least the temperature of the window member and the internal temperature of the heating chamber.

15. The heating cooker of claim 1, further comprising an in-sensor temperature detection unit configured to detect an internal temperature of the food ingredient temperature detection unit,
wherein the control processor is further configured to correct the surface temperature of the food ingredient detected by the food ingredient temperature detection unit based on at least the temperature of the window member and the internal temperature of the food ingredient temperature detection unit.
